(19) United States
(12) Patent Application Publication
(10) Pub. No.: US 2016/0101395 A1
(43) Pub. Date: Apr. 14, 2016

(54) LIQUID MIXER FOR MIXING NAIL POLISH

(71) Applicant: Alaa HUSSAIN, Muharraq (BH)

(72) Inventor: Alaa Hussain, Muharraq (BH)

(21) Appl. No.: 14/891,662

(22) PCT Filed: May 15, 2014
(86) PCT No.: PCT/IB2014/061473

§ 371 Date: Nov. 16, 2015

(30) Foreign Application Priority Data
May 15, 2013 (BH) 20130056

(51) Int. Cl. B01F 13/10; B01F 7/16; B01F 15/02; B01F 3/08

(52) U.S. Cl. CPC B01F 13/1063; B01F 3/0853; B01F 7/161; B01F 15/0261; B01F 13/1066; B01F 2215/0031

(57) ABSTRACT

A (Liquid Mixer for mixing nail polish) is invention electronic machines that has the basic colors of nail polish liquid in containers, and can mix them to create many different polish color shade as user choose by computer software program interface . It can also make the three types of nail polish colors (normal/glitter/matt) in very short time, which will save time and money for the user.

### BACKGROUND OF THE INVENTION

1. Field of the Invention

The present disclosure generally is related to fashion electronic machine, and more particularly, a nail polish mixer machine which can produce new nail polish color shades by mixing the basic colors.

The same machine with same functionality could use for:
Mixing painting liquid colors.
Mixing different Juices.
Mixing medicines.

2. Description of the Related Art

Through a research, we found that there are nail polish mixers for factories, where they mix every color shade separately in different machines, and the size of these machines is big. from that we have to buy many nail polish color shade bottle, which is still we need to go for shopping and buy many different nail polish colors and shades.

Also there is “ Hand nail polish mixer kit”, the user mixes the nail polish to get the shade she wants by hands, so she need to buy kits and tools need it every time, she spend time and effort for each color, this process might dirty the workplace, and after all the result we found could not be exactly as she wants.

### BRIEF SUMMARY OF THE INVENTION

The invention has two parts, a software part and a hardware one, where the software is a program to control the hardware machine.

The software is a visual basic program that works as a user interface to allow the user to choose the color shade needed in two ways: writing RGB code color, or choosing from the color dialog. The program can save numbers of picked color shades so user can use the same shade color again.

Where the hardware part is the machine which will mix the chosen color shade from the software this machine is consist of five containers (1 in fig.)which contain the five basic colors (cyan , magenta, yellow, black and white) in addition two containers , one for glitter and one for matt liquid (which makes the nail polish turns to a matt color). The liquids containers is dropping specific drops number by “Valves”(2 in fig.), these valves are controlled by an Arduino microcontroller board (10 in fig.).

These polish liquid drops will drop in a small plastic cup (8 in fig) to be mixed by a mixing stick (7 in fig) which is rotating by a DC motor (6 in fig) controlled by the Arduino.

### BRIEF DESCRIPTION OF THE SEVERAL VIEWS OF THE DRAWING(S)

FIG. 1: The invention's design

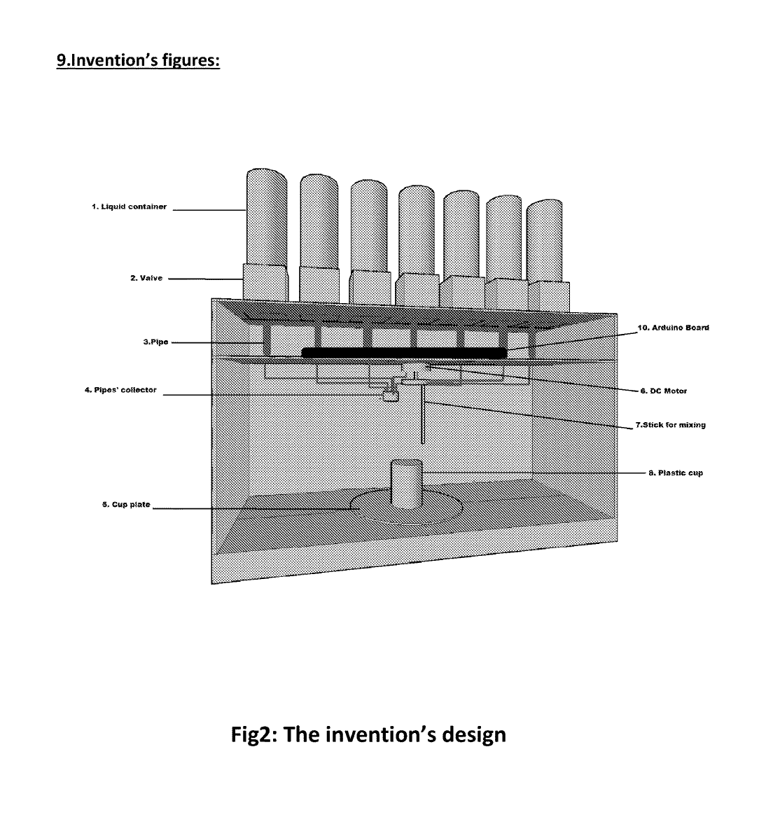

FIG. 2: The invention's design during Mixing stage

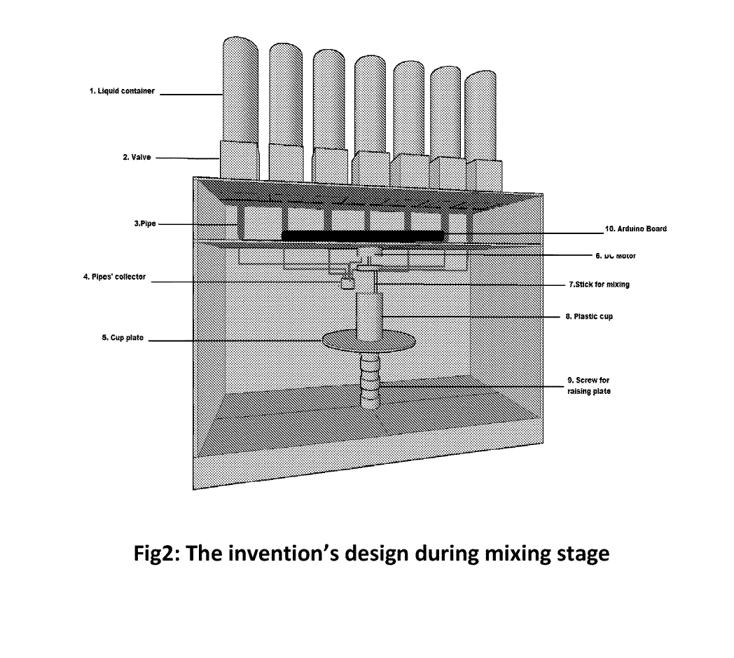

FIG. 3: Arduino board circuit

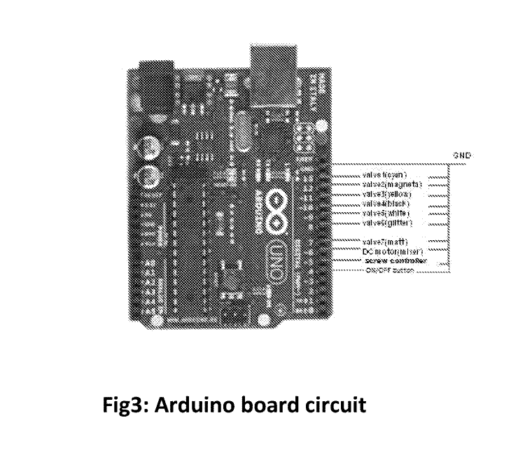

### DETAILED DESCRIPTION OF THE INVENTION

The following detailed description is directed toward machines for mixing nail polish color shades from the basic nail polish colors, by choosing the shade from a user software interface. The following detailed description and corresponding figures are intended to provide an individual of ordinary skill in the art with enough information to enable that individual to make and use embodiments of the invention. Such an individual, however, having read this entire detailed description and reviewed the figures, will appreciate that modifications can be made to the illustrated and described embodiments, and/or elements removed therefrom, without deviating from the spirit of the invention. It is intended that all such modifications and deviations fall within the scope of the invention, to the extent they are within the scope of the associated claims.

Reference throughout this specification to “one embodiment” or “an embodiment” means that a particular feature, structure or characteristic described in connection with the embodiment is included in at least one embodiment of the disclosed methods and structures. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

### This Invention has Three Phases for the Processing

Choosing color shade from a computer software
Controlling valves to drop specific values
Mixing all color drops

### Phase1: Choosing Color Shade from a Computer Software

A simple software interface window is designed by Visual basic(2010) Language to let the user to choose the color shade needed by two methods:

1—by writing RGB code in three textbox and the result will shows in a square (to make sure this is the needed color),

2—By choosing a color shade from the color dialog,—which user already familiar with that—and the chosen color shade will shows in the square, and will shows the RGB code for that color in the three text boxes.

In addition, the color shade can by save—if the user need to use the exactly same color shade Again—and can be deleted.

Also user can choose if the chosen color shade is normal, matt, or glittered.

After the user makes sure that this is the color shade needed , there is a button which shows a massage box to check if user is sure or not, if yes, then the RGB code color(Red ,Green, and Yellow) will transfer to another code for five basic colors (cyan , magenta ,Yellow ,Black , and white) to use it for mixing the nail polish color shade chosen (this technique is used in printers called CMYK , but without the white color because the paper already white, so I concluded to a formula for counting the percentage for white color). The five colors' percentage will be divided by 40, which is the total number for drops for all the five colors, so each one of the five basic color will has number of drops out of the total drops—which is 40—. These five numbers and (matt or glitter or normal value) will be sent to the machine (Arduino board) as inputs through the USB cable (same USB port for power, and coding the Arduino microcontroller).

### Phase2: Controlling Valves to Drop Specific Values

The machine contain a microcontroller board “Arduino Uno” , based on the ATmega328 .It has 14 digital input/output pins (of which 6 can be used as PWM outputs), 6 analog inputs, a 16 MHz ceramic resonator, a USB connection, a power jack, an ICSP header, and a reset button. It can connect to a computer with a USB cable or power it with a AC-to-DC adapter or battery to get started.

### Summary Arduino Specification

| | |
|---|---|
| Microcontroller | ATimega328 |
| Operating Voltage | 5 V |
| input Voltage | 7-12 V |
| (recommended) | |
| Input Voltage (limits) | 6-20 V |
| Digital I/O Pins | 14 (of which 6 provide PWM output) |
| Analog Input Pins | 6 |
| DC Current per I/O Pin | 40 mA |
| DC Current or 3.3 V Pin | 50 mA |
| Flash Memory | 32 KB (ATmega328) of which |
| | 0.5 KB used by bootloader |
| SRAM | 2 KB (ATmega328) |
| EEPROM | 1 KB (ATmega328) |
| Clock Speed | 16 MHz |

The Arduino board (10 in fig) is connected to computer by a USB cable to take power needed , and to take the percentage and number of drops for each basic nail polish color as inputs from the software. This board is used basically to control all the machine's components (valves, DC motor, LCD screen . . . etc.)—When all these turn on and when they turn off—by a C language code saved in the Arduino.

The inputs for the Arduino are the code with five values (2 in fig) for drops for each of the five basic colors and (matt/glitter/normal value) comes through the USB cable.

First user must open the interface visual basic program, and then choose the color from the software. After that, the software send the number of drops for each basic color to the Arduino board, the Arduino (10 in fig) will start controlling to the valves (2 in fig) which are connected to the nail polish containers (1 in fig). Each valve of each color will drop number of drops as the value of the sent code for that shade color. The used valves are: Solenoid Valve ¼ NPT Air Water Gas 12V DC w/2 Brass Hose Barb NPT. Each valve is connected to a pipe (3 in fig) which is connected to valves collector (4 in fig).this collector is for collecting all valves' pipes and take these drops to the plastic cup (8 in FIG.

Phase3: Mixing All Color Drops

First, user has to put a plastic cup (8 in fig) on the cup plate (5 in fig). After that, the cup's plate (5 in fig) will go up for mixing process by rotating the screw (9 in fig). All that drops of nail polish will drop in a plastic cup—user has to put it—and mix by a stick (7 in fig) glued to a DC motor (same DC motor in DVD reader). This stick will rotate with the DC motor(6 in fig) rotating motion; the polish drops will be mixed.

As said previously, the total number of drops will be 20 drops from the five basic colors, and because each valve drops ¼ ml, so the total result size will be 5 ml (enough for one time use).

After mixing process is finished, the cup plate will go down by rotating the screw (9 in fig) so user can take the mixed polish. This plate based on a DC motor connected to the Arduino (10 in fig) and controlled by it.

### Ideas and Functions will be Added to the Invention

### Choosing Color by Color Sensor

The idea is to add a color sensor. This sensor is to catch any color user want to have same nail polish shade color, for example from a dress color, or another nail polish color already used, or anything else.

### Link the Software to Nail Polish Websites

Linking the invention software to internet, with nail polish companies' websites, so user can has same exactly color shade which is sale in any nail polish company.

### Making Nail Polish Stamp

Stamping Nail Art is—imprinting kit that lets you put designs by stamping pre-designed images on your nails in minutes. There are many kit that can be used manually, but in our invention you can choose the design from the software with the color, and it will stamp it on user nail.

### Polishing User Fingers Electronically

The user can put her hand under a big glass and sensors (as scanner) which can find the location and size of each nail of the hand, and then it put polish on it .

### Choosing the Polish'S Color by Rotation Button

As the radio sound adjustment button, a rotation but rounded by a rainbow color sticker, the user can choose the color shade by rotating that button to the color shade wanted.

### Connecting Machine to Computer by Bluetooth

Instead of connecting the mixer machine to computer by USB cable, it can be connected by Bluetooth.

### Camera Takes Photo for User'S Hand After Polishing and Designing

### A Smart Phone Application/Website for Sharing Best Color Shades as Fashion and Publishing Hands' Photo after Design

As said in 7.6 that a camera is connected to take photos for users' hands, the user can has an account in that a smart phone application/website to download these photos and sharing their nails art and designs—like social networking websites and applications—. Also users can exchange their experience and best colors code they have tried .

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A device for mixing liquids of nail polish, the device comprising:
Containers for keeping the basic colors of nail polish liquids ended with Valves to control the drops outing from the containers, connected to a Mixer stick which is a DC Motor for rotation and that stick comes inside the cup for mixing. An Arduino microcontroller board for controlling valves, mixer Dc motor and cup's plate DC motor. The Arduino is connected to the computer by USB cable, where there is visual basic 2010 software is used as a program interface to let the user to choose the color shade needed. Also the Arduino takes power from that USB cable, where the other components take power from power supplier.

2—The device of claim 1, containers for the five basic colors and glitter and matt can be controlled by valves.

3—The device of claim 1, connect the valve with the valves collector for dropping all polish drops.

4—The device of claim 1, a DC motor for rotation and a stick for mixing all drops.

5—The device of claim 1, cup's plate to go up and down for mixing and down when it is ready to use.

6—The device of claim 1, a software program to let user choose the color shade needed .

8—The device of claim 1, software functions to let user choose the color shade by two ways: by entering RGB code numbers, or by selecting from color dialog. Another function for saving the colors user liked to let user to use it again, and a deleting the saved colors.

9—The device of claim 1, a function for transfer the RGB color code number to CMYK color code number, and a new created function to find the white color percentage from that color from the other basic colors codes.

10—The device of claim 1, sending data from computer to the machine's Arduino microcontroller by USB cable.

11—The device of claim 1, a liquid for matting the nail polish, and another one for glitter the nail polish.
